(19) United States
(12) Patent Application Publication
(10) Pub. No.: US 2014/0096332 A1
(43) Pub. Date: Apr. 10, 2014

(54) ELECTRIC TOOTHBRUSH

(71) Applicant: PANASONIC CORPORATION, Osaka (JP)

(72) Inventors: Tadanobu Kitagawa, Shiga (JP); Masayuki Sagawa, Shiga (JP); Seiichi Iwao, Shiga (JP)

(73) Assignee: PANASONIC CORPORATION, Osaka (JP)

(21) Appl. No.: 14/119,706

(22) PCT Filed: Apr. 12, 2012
(86) PCT No.: PCT/JP2012/060009

§ 371 Date: Nov. 22, 2013

(30) Foreign Application Priority Data
May 31, 2011 (JP) 2011-122934
May 31, 2011 (JP) 2011-122935

(51) Int. Cl. A61C 17/34; A46B 15/00

(52) U.S. Cl. CPC A61C 17/3481; A46B 15/0036
USPC 15/22.1

(57) ABSTRACT

The electric toothbrush, which is able to illuminate the brush part more brightly, comprises a main body case that holds a battery, and an attachment that has the brush part. When the attachment is attached to the main body case, the attachment shaft of the main body case is fitted into the attachment. A light source is provided in a portion of the attachment shaft.

### TECHNICAL FIELD

The present invention relates to an electric toothbrush.

### BACKGROUND ART

An electric toothbrush described in Patent Document 1 includes a main body member, which accommodates a power supply, and a cleaning member, which is coupled to the main body member in a removable manner. The main body member includes a light source, which illuminates the inside of the mouth when cleaning teeth.

An electric toothbrush described in Patent Document 1 includes a light source connected to a control board with a lead wire.

### PRIOR ART DOCUMENTS

### Patent Document

Patent Document 1: Japanese Laid-Open Patent Publication No. 2005-296516
Patent Document 2: Japanese Laid-Open Patent Publication No. 2003-47528

### SUMMARY OF THE INVENTION

The electric toothbrush described in Patent Document 1, which includes the light source arranged inside the main body member, may not be able to sufficiently illuminate the brush portion of the cleaning member when cleaning teeth.

The electric toothbrush described in Patent Document 2 includes the light source and the control board that are relatively small to fit into the main body member. As the light source and the control board become farther from each other in the main body member, that is, as the lead wire connecting the light source and the control board becomes longer, the assembling process of the electric toothbrush may become complicated. The same problem occurs to any other electric toothbrush that includes a functional unit other than the light source.

It is an object of the present invention to provide an electric toothbrush that solves all or some of the problems in the prior art.

One aspect of the present invention is an electric toothbrush including a main body member accommodating a power supply. A cleaning member is coupled to the main body member in a removable manner. The cleaning member includes a brush portion. A coupling shaft is arranged on the main body member. The coupling shaft is received by the cleaning member when the cleaning member is coupled to the main body member. A light source is arranged in a portion of the coupling shaft that is covered by the cleaning member.

Preferably, the light source is arranged in a distal portion of the coupling shaft.

Preferably, the electric toothbrush includes a vibration generator arranged in the main body member. At least a portion of the vibration generator is arranged in the coupling shaft.

Preferably, the light source is arranged in a portion of the coupling shaft that is closer to the brush portion than the vibration generator.

Preferably, the light source emits light toward the brush portion.

Preferably, the cleaning member includes an outer wall surrounding the coupling shaft, and a portion of the outer wall between the brush portion and the light source is formed from a transparent material.

Preferably, bristles of the brush portion are arranged on a front surface of the brush portion, and the transparent member is arranged on a front surface of the outer wall.

Preferably, the front surface of the outer wall includes a front inclined portion inclined in a manner to approach a center line of the main body member in a direction from the main body member toward the brush portion.

Preferably, the transparent member is inclined toward the brush portion.

Preferably, the electric toothbrush further includes a reflective member that reflects light from the light source toward the transparent member.

Preferably, the brush portion includes a bristle embedding surface in which brush bristles are embedded, and the bristle embedding surface is arranged frontward from a center line of the main body member.

Preferably, the electric toothbrush further includes a cap covering the cleaning member, and the cap includes a ventilation hole that faces distal ends of brush bristles of the brush portion.

Preferably, the electric toothbrush further includes a control board that controls the light source and a relay board that electrically connects the functional portion and the control board. The functional portion, the control board, and the relay board are arranged in the main body member.

Preferably, the main body member includes a supporting member. The light source, the vibration generator, and the relay board are coupled to the supporting member.

Preferably, the supporting member includes a terminal groove formed for arrangement of a connection terminal of the light source.

Preferably, the electric toothbrush further includes a device lead wire that connects the vibration generator and the control board and a board lead wire that connects the relay board and the control board. The relay board and the control board are arranged parallel to each other and parallel to a center line of the main body member. The control board includes a first connecting portion, which is connected to the device lead wire, and a second connecting portion, which is connected to the board lead wire, and the first connecting portion and the second connecting portion are respectively arranged at the same height in a first area and a second area sandwiching the center line of the main body member. The relay board includes a third connecting portion connected to the board lead wire, and the third connecting portion is formed at a position corresponding to the second area of the control board including the second connecting portion.

Preferably, the electric toothbrush includes a device lead wire that connects the vibration generator and the control board, a board lead wire that connects the relay board and the control board, and an isolating means arranged in the main body member to isolate the device lead wire from the board lead wire.

In one example, the light source and the relay board are arranged in a portion of the coupling shaft that is covered by the cleaning member. At least a portion of the control board is arranged in a portion of the main body member that is not covered by the cleaning member.

An aspect of the present invention provides an electric toothbrush that is able to sufficiently illuminate the brush portion. In addition, an aspect of the present invention provides an electric toothbrush that is easily assembled.

### BRIEF DESCRIPTION OF THE DRAWINGS

FIG. 1A is a front view of a main body member of a toothbrush, and FIG. 1B is a side view of the main body member of the toothbrush from which an attachment is removed;

FIG. 2A is a front view of the electric toothbrush on which a cap is coupled to the main body member, FIG. 2B is a side view of the electric toothbrush shown in FIG. 2A, and FIG. 2C is a rear view of the electric toothbrush shown in FIG. 2A;

FIG. 3A is a cross-sectional view taken along line A-A in FIG. 2A, and FIG. 3B is a partially enlarged view of FIG. 3A;

FIGS. 4A, 4B, and 4C are respectively a front view, a side view, and a rear view of a transparent member;

FIG. 5A is a cross-sectional view of a brush handle, and FIG. 5B is a cross-sectional view taken along line B-B in FIG. 5A;

FIG. 6 is an enlarged view of an attachment and a coupling shaft of an electric toothbrush according to a second embodiment;

FIG. 7A is a perspective view of the electric toothbrush of the second embodiment showing the rear of its inner case, and FIG. 7B is a plan view of part of the inner case to which a control board is coupled;

FIGS. 8A and 8B are a partial perspective view and a partial plan view of the inner case of the electric toothbrush according to the second embodiment;

FIGS. 9A and 9B are a front view and a cross-sectional view of a distal end of a cap of an electric toothbrush in a modification;

FIG. 10 is a partial cross-sectional view of the electric toothbrush in a modification; and

FIGS. 11A and 11B are a side view and a cross-sectional view of a referential example of an electric toothbrush.

### DESCRIPTION OF EMBODIMENTS

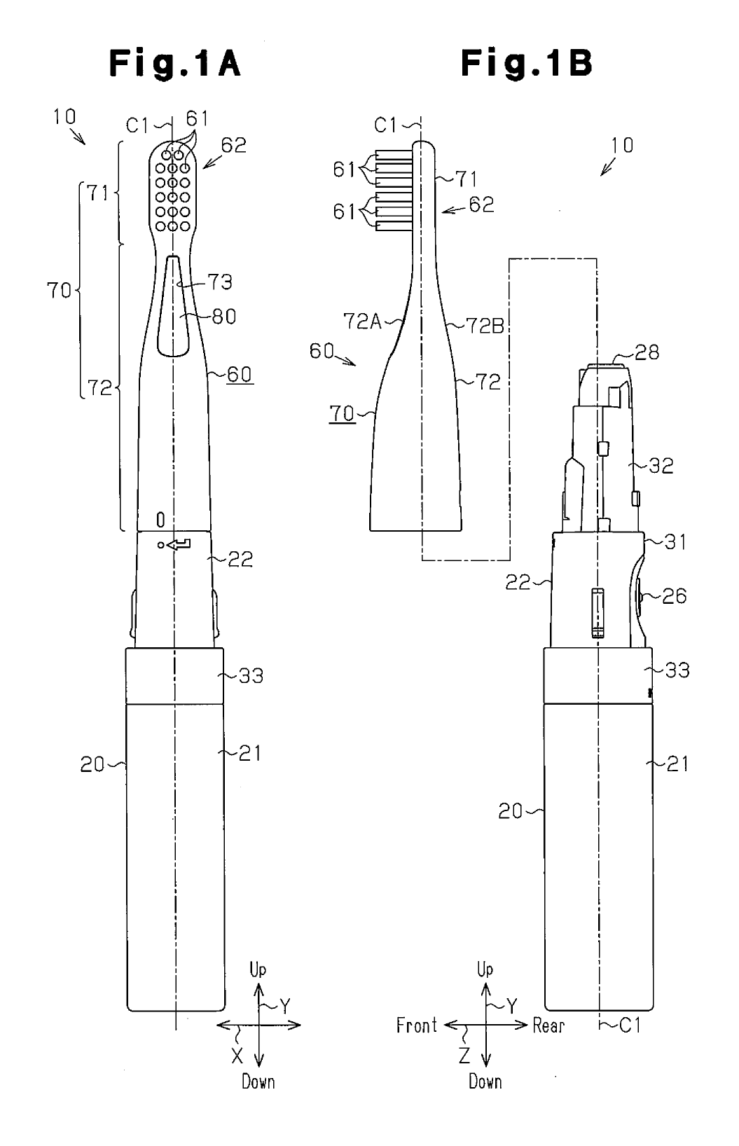

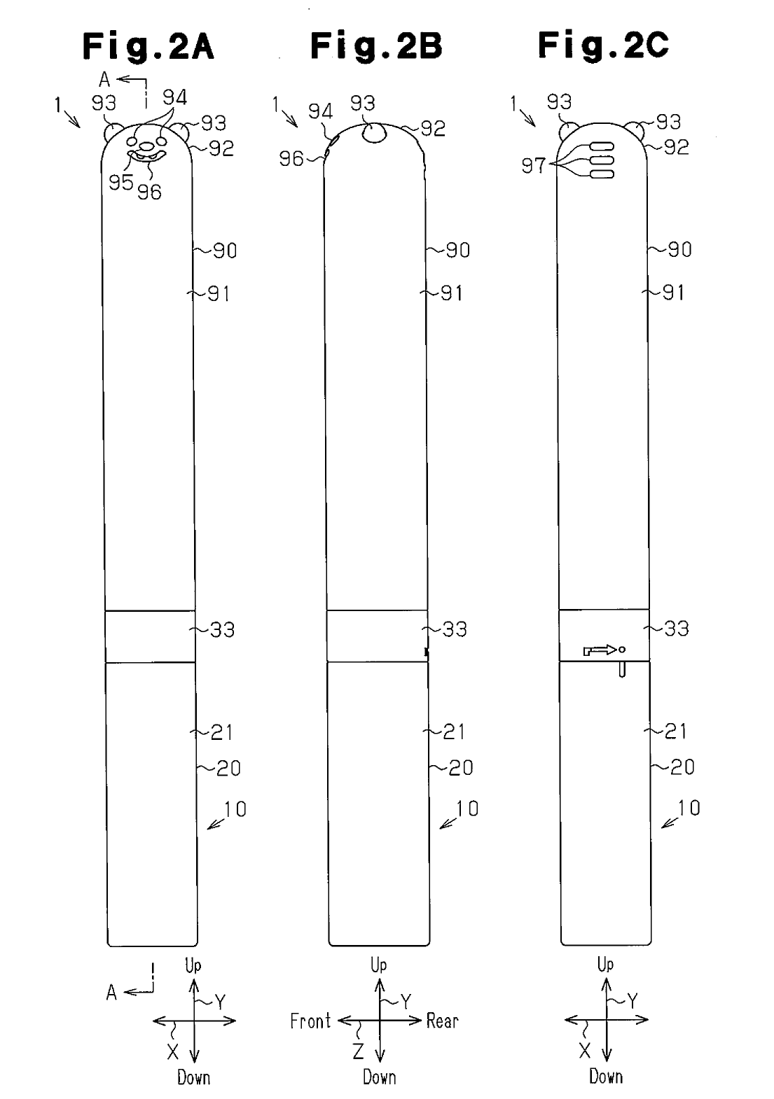

Referring to FIG. 1A to FIG. 2C, the schematic structure of an electric toothbrush 1 according to a first embodiment will now be described.

As shown in FIGS. 2A to 2C, the electric toothbrush 1 includes a toothbrush body 10, and a cap 90, which is coupled to the toothbrush body 10 to store the toothbrush body 10.

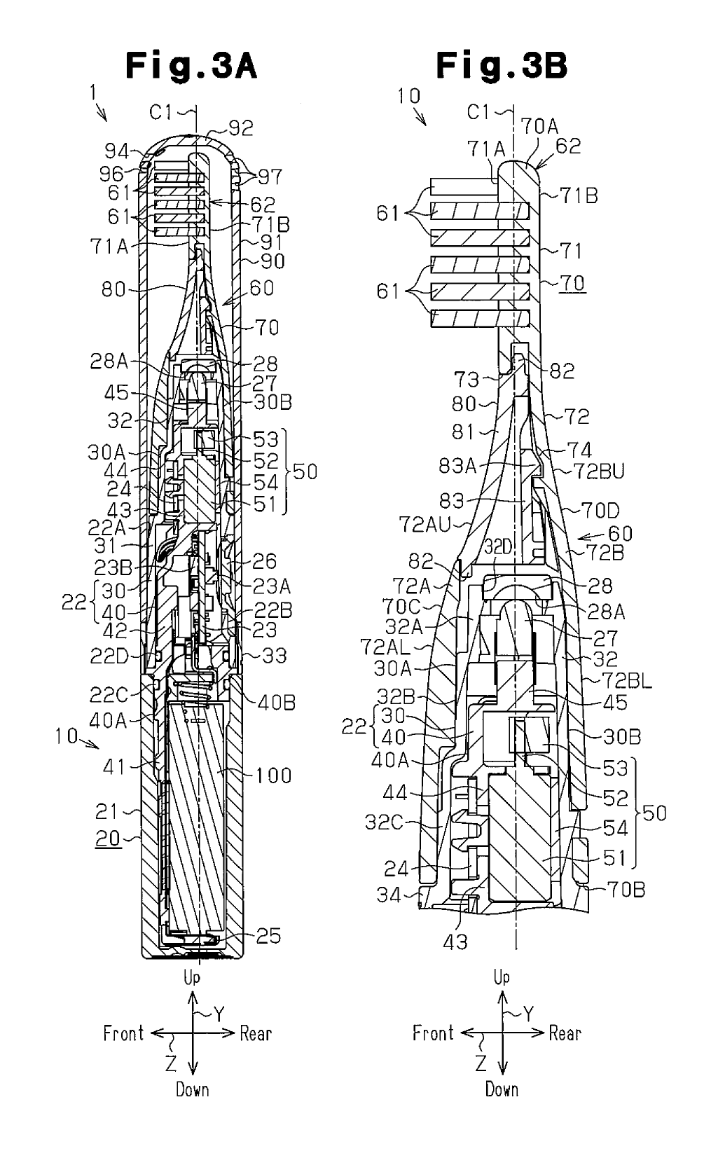

As shown in FIGS. 1A and 1B, the toothbrush body 10 includes a main unit 20, which incorporates various components including a battery 100 (FIGS. 3A and 3B) that functions as a power supply, and an attachment 60, which is used for cleaning teeth.

The main unit 20 includes a grip case 21, which is gripped by the user when cleaning teeth, and a body case 22, to which the components of the main unit 20 are coupled. The body case 22 corresponds to a main body member.

As shown in FIG. 1B, the body case 22 includes a coupling shaft 32, to which the attachment 60 is coupled. In the illustrated example, the coupling shaft 32 is tubular. The attachment 60 corresponds to a cleaning member.

The attachment 60 is coupled to the coupling shaft 32 in a removable manner. The attachment 60 includes a brush portion 62.

In the illustrated example, a brush handle 70 includes a distal portion 71, in which a plurality of brush bristles 61 (filaments) are embedded, and a wall 72 surrounding the coupling shaft 32 of the body case 22. The wall 72 may be referred to as a basal portion or a hollow portion of the brush handle 70. The brush handle 70 may be formed from resin. In some examples, the brush handle 70 may be formed from a white resin material. The brush portion 62 refers to a part that includes the distal portion 71 of the brush handle 70 and the brush bristles 61.

The directions indicating relative positions of the components of the electric toothbrush 1 are defined as follows. The height direction Y is the direction extending along the center line C1 of the toothbrush body 10. The depth direction Z is a direction orthogonal to the height direction Y as viewed from the front of the toothbrush body 10 (FIG. 1A). The width direction X is a direction orthogonal to the height direction Y as viewed from the side of the toothbrush body 10 (FIG. 1B). An upper side is in the direction from the grip case 21 toward the attachment 60 in the height direction Y. A lower side is opposite to the upper side in the height direction Y. The front is in the direction from the roots of the brush bristles 61 toward their tips. The rear is opposite to the front. The side cross-section is a cross-section parallel to a plane defined by the body center line C1 and the longitudinal axis of each brush bristle 61 (FIGS. 3A and 3B).

As shown in FIG. 1B, the main unit 20 includes an operational member 26 for switching the operation of the toothbrush body 10. The operational member 26 is arranged downward from the coupling shaft 32 and rearward from the body center line C1.

As shown in FIG. 1A, the front surface of the wall 72 has a window, or an opening 73. The dimension of the wall 72 in the width direction X decreases from the lower side toward the upper side. The dimension of the opening 73 in the height direction Y is larger than the dimension of the opening 73 in the width direction X. The dimension of the opening 73 in the width direction X decreases from the lower side toward the upper side in the height direction Y.

A transparent member 80 is set in the opening 73. The transmittance of the transparent member 80 is greater than the transmittance of the resin material used for the brush handle 70. The transparent member 80 may be a transparent resin member formed from, for example, acrylonitrile butadiene styrene (ABS) resin.

As shown in FIG. 1B, the front surface of the wall 72 includes a front inclined portion 72A, which is inclined to approach the body center line C1 in a direction from the lower side toward the upper side. The rear surface of the wall 72 includes a rear inclined portion 72B, which is inclined to approach the body center line C1 in the direction from the lower side toward the upper side. The angle of inclination of the front inclined portion 72A relative to the body center line C1 is larger than the angle of inclination of the rear inclined portion 72B. The transparent member 80 forms a portion of the front inclined portion 72A. For example, the outer surface of the transparent member 80 is inclined to conform to the outer surface of the front inclined portion 72A.

The cap 90 will now be described with reference to FIGS. 2A to 2C.

The cap 90 includes a circumferential wall 91, which covers the sides of the brush handle 70 shown in FIGS. 1A and 1B, and a top wall 92, which covers the top of the brush portion 62 shown in FIGS. 1A and 1B. In the illustrated example, the circumferential wall 91 is tubular, and the top wall 92 is semispherical. The top wall 92 may include an ornamental portion that showing the head of an animal.

As shown in FIGS. 2A and 2B, the top wall 92 includes two semispherical protrusions 93 on its distal end. On its front surface, the top wall 92 has two circular ventilation holes 94, an oval ventilation hole 95, and a curved ventilation hole 96. The ventilation holes 94 to 96 face the distal ends of the brush bristles 61 in the depth direction Z (refer to FIGS. 3A and 3B).

The protrusions 93, the two ventilation holes 94, the ventilation hole 95, and the ventilation hole 96 are shaped and positioned to enable the front surface of the cap 90 so that the face of an animal can be recognized.

On its rear surface, as shown in FIG. 2C, the cap 90 has three ventilation holes 97, which are aligned with one another in the height direction Y. The ventilation hole 97 at the top is formed at an intermediate position in the top wall 92. The ventilation hole 97 in the middle is at the bottom position of the top wall 92. The ventilation hole 97 at the bottom is at the top position of the circumferential wall 91. Each ventilation hole 97 is oval. The dimension of the ventilation hole 97 in the width direction X is larger than the dimension of the corresponding ventilation hole 97 in the height direction Y. The three ventilation holes 97 and the two protrusions 93 are shaped and positioned to enable the rear surface of the cap 90 so that the rear of the animal head can be recognized.

The interior of the toothbrush body 10 will now be described with reference to FIGS. 3A and 3B. The body case 22 includes an inner case 40, to which a plurality of components are coupled, and an outer case 30, which partially covers the inner case 40.

The body case 22 accommodates a control board 23, which includes a switch 23A and a microcomputer 23B (hereafter, computer 23B), a connector 25, which electrically connects the battery 100 and the control board 23, a vibration generator 50, a light source 27, which emits light toward the brush portion 62, a relay board 24, which connects the control board 23 and the light source 27, and a cover 28, which covers the light source 27 from above.

The switch 23A may be, for example, a tactile switch. The light source 27 may be, for example, a light emitting diode. The cover 28 may be a transparent resin member formed from, for example, ABS resin.

The switch 23A is depressed when the operational member 26 is depressed. The computer 23B controls the operation of the toothbrush body 10 based on a signal input whenever the switch 23A is depressed.

The vibration generator 50 includes an electric motor 51, which has an output shaft 52, an eccentric weight 53, which is fixed to the output shaft 52, and a vibration transmission member 54 that transmits vibrations, which are generated when the electric motor 51 is driven, to the body case 22. The center of gravity of the eccentric weight 53 is eccentric relative to the output shaft 52. The vibration transmission member 54 is fixed to the electric motor 51. The outer surface of the vibration transmission member 54 is in contact with a rear surface 30B of the outer case 30.

The outer case 30 includes a tubular case body 31, to which the operational member 26 is coupled, and a coupling shaft 32, which is continuous with the upper portion of the case body 31. The coupling shaft 32 is formed integrally with the case body 31. A decoration member 33 is coupled to the outer surface of a bottom portion of the case body 31.

As shown in the side cross-section of FIG. 3B, the coupling shaft 32 includes three parts differing in dimension in the depth direction Z, namely, a distal end shaft 32A, an intermediate shaft 32B, and a basal end shaft 32C. The distal end shaft 32A, the intermediate shaft 32B, and the basal end shaft 32C are arranged in this order from the upper side toward the lower side. The dimension of the distal end shaft 32A in the depth direction Z is smaller than that of the intermediate shaft 32B. The dimension of the intermediate shaft 32B in the depth direction Z is smaller than that of the basal end shaft 32C.

The distal end shaft 32A includes an opening 32D on its top. The cover 28 is pressed and fitted in the opening 32D. The upper surface of the cover 28 may be a flat surface defined by the depth direction Z and the width direction X. The lower surface of the cover 28 includes a semispherical recess 28A.

As shown in FIG. 3A, the inner case 40 includes five coupling portions that allow various components to be coupled to the case, namely, a first coupling portion 41, a second coupling portion 42, a third coupling portion 43, a fourth coupling portion 44, and a fifth coupling portion 45. The first coupling portion 41, the second coupling portion 42, the third coupling portion 43, the fourth coupling portion 44, and the fifth coupling portion 45 are arranged in this order from the lower side toward the upper side.

The battery 100 is coupled to the first coupling portion 41. The control board 23 is coupled to the coupling portion 42. The relay board 24 is coupled to the third coupling portion 43. The vibration generator 50 is coupled to the fourth coupling portion 44. The light source 27 is coupled to the fifth coupling portion 45. The fifth coupling portion 45 may be solid, and may have, for example, the shape of a prism. Each of the first to fifth coupling portions 41 to 45 may include a mechanical supporting structure and an electric connecting structure.

As shown in FIG. 3B, the coupling shaft 32 accommodates the third coupling portion 43, the fourth coupling portion 44, and the fifth coupling portion 45 of the inner case 40. Thus, the coupling shaft 32 accommodates the relay board 24, the vibration generator 50, and the light source 27. The case body 31 accommodates the first coupling portion 41 to which the battery 100 has been coupled and the second coupling portion 42 onto which the control board 23 has been coupled.

The positions of the components in the toothbrush body 10 will now be described with reference to FIG. 3A. The outer surface of the brush handle 70 includes a front surface 70C and a rear surface 70D. In the front surface 70C of the brush handle 70, a front surface of the distal portion 71 forms a bristle embedding surface 71A. In the rear surface 70D of the brush handle 70, a rear surface of the distal portion 71 forms a rear head surface 71B.

The control board 23 is arranged upward from the battery 100. The relay board 24 is arranged upward from the control board 23. The vibration generator 50 is arranged to overlap a portion of the relay board 24 in the height direction Y. The light source 27 is arranged upward from the relay board 24 and the vibration generator 50. The light source 27 is arranged rearward from the bristle embedding surface 71A and frontward from the rear head surface 71B. The tip of the light source 27 is arranged at a position corresponding to the bottom surface of the cover 28 in the height direction Y. The transparent member 80 is arranged upward from the light source 27 and downward from the brush portion 62. The bottom end of the transparent member 80 is near the top end of the coupling shaft 32.

The brush handle 70 will now be described with reference to FIG. 3B. A front surface length V is the length of the front surface 70C of the brush handle 70 from a distal end 70A to a basal end 70B of the brush handle 70. A rear surface length W is the length of the rear surface 70D of the brush handle 70 from the distal end 70A to the basal end 70B. An upper inclined portion 72AU is a portion of the front inclined portion 72A that is between the boundary of the wall 72 with the distal portion 71 and the upper part of the light source 27. A lower inclined portion 72AL is a portion of the front inclined portion 72A corresponding to the vibration generator 50 and the light source 27. An upper inclined portion 72BU is a portion of the rear inclined portion 72B that is between the boundary of the wall 72 with the distal portion 71 and the upper part of the light source 27. A lower inclined portion 72BL is a portion of the rear inclined portion 72B corresponding to the vibration generator 50 and the light source 27.

The bristle embedding surface 71A is formed frontward from the body center line C1 and rearward from the front inclined portion 72A. The rear head surface 71B is formed rearward from the body center line C1 and frontward from the rear inclined portion 72B. The rear surface length W is smaller than the front surface length V.

The front inclined portion 72A is formed frontward from the body center line C1. The front inclined portion 72A is inclined from the front toward the rear in a direction from the lower side toward the upper side. The angle of inclination of the upper inclined portion 72AU relative to the body center line C1 is larger than the angle of inclination of the lower inclined portion 72AL relative to the body center line C1.

The rear inclined portion 72B is formed rearward from the body center line C1. The rear inclined portion 72B is inclined from the rear toward to the front in a direction from the lower side toward the upper side. The inclination angle of the upper inclined portion 72BU is larger than the inclination angle of the lower inclined portion 72BL.

The inclination angle of the upper inclined portion 72AU of the front inclined portion 72A is larger than the inclination angle of the upper inclined portion 72BU of the rear inclined portion 72B. The inclination angle of the lower inclined portion 72AL of the front inclined portion 72A is smaller than the inclination angle of the upper inclined portion 72BU of the rear inclined portion 72B.

The structure of the main unit 20 will now be described in detail with reference to FIGS. 3A and 3B.

As shown in FIG. 3A, a body case front surface 22A includes an outer case front surface 30A and an inner case front surface 40A. The body case rear surface 22B includes an outer case rear surface 30B and an inner case rear surface 40B. A front wall length P is the length of a portion of the body case front surface 22A that faces the grip case 21. A rear wall length Q is the length of a portion of the body case rear surface 22B that faces the grip case 21. The rear wall length Q is smaller than the front wall length P. The front wall length P and the rear wall length Q are the lengths of parts of the body case front surface 22A and the body case rear surface 22B that directly face the inner surface of the grip case 21.

As shown in FIG. 3B, the outer case front surface 30A is arranged frontward from the inner case front surface 40A. The front surface 70C of the brush handle 70 is arranged frontward from the outer case front surface 30A. The connecting portion of the case body 31 and the coupling shaft 32 includes a step 34. The bottom end surface of the brush handle 70 faces the upper surface of the step 34.

The seal structure of the toothbrush body 10 will now be described with reference to FIG. 3A.

A grip sealing member 22C seals the space between the grip case 21 and the body case 22. The grip sealing member 22C is applied to the inner case 40 at a position upward from the first coupling portion 41 and downward from the top end surface of the grip case 21.

A body sealing member 22D seals the space between the outer case 30 and the inner case 40. The body sealing member 22D is applied to the inner case 40 at a position upward from the top end surface of the grip case 21 and downward from the second coupling portion 42.

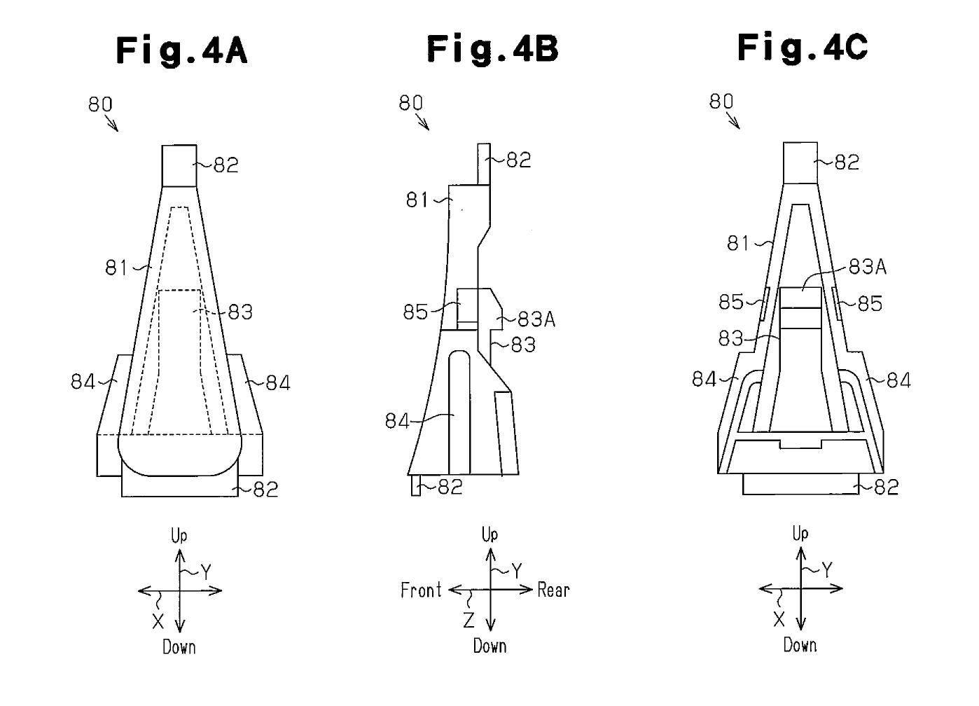

The transparent member 80 will now be described with reference to FIGS. 4A to 4C.

As shown in FIG. 4A, the transparent member 80 includes a window portion 81, which corresponds to the opening 73 of the brush handle 70 shown in FIGS. 1A and 1B, external retaining portions 82, which restrict forward movement of the transparent member 80, and an internal retaining portion 83, which restricts downward movement of the transparent member 80. The external retaining portions 82 are formed on the upper end and the lower end of the window portion 81.

As shown in FIG. 4B, the internal retaining portion 83 is formed on the rear of the window portion 81. A hook 83A, which is engaged with the brush handle 70, is formed on the distal end of the internal retaining portion 83. The dimension of the internal retaining portion 83 in the height direction Y is larger than the dimension of the internal retaining portion 83 in the width direction X.

As shown in FIG. 4C, wing portions 84, which outwardly protrude from the two ends of the window portion 81, and fitting portions 85, which restrict downward movement of the transparent member 80, are formed at the two ends of the window portion 81 in the width direction X.

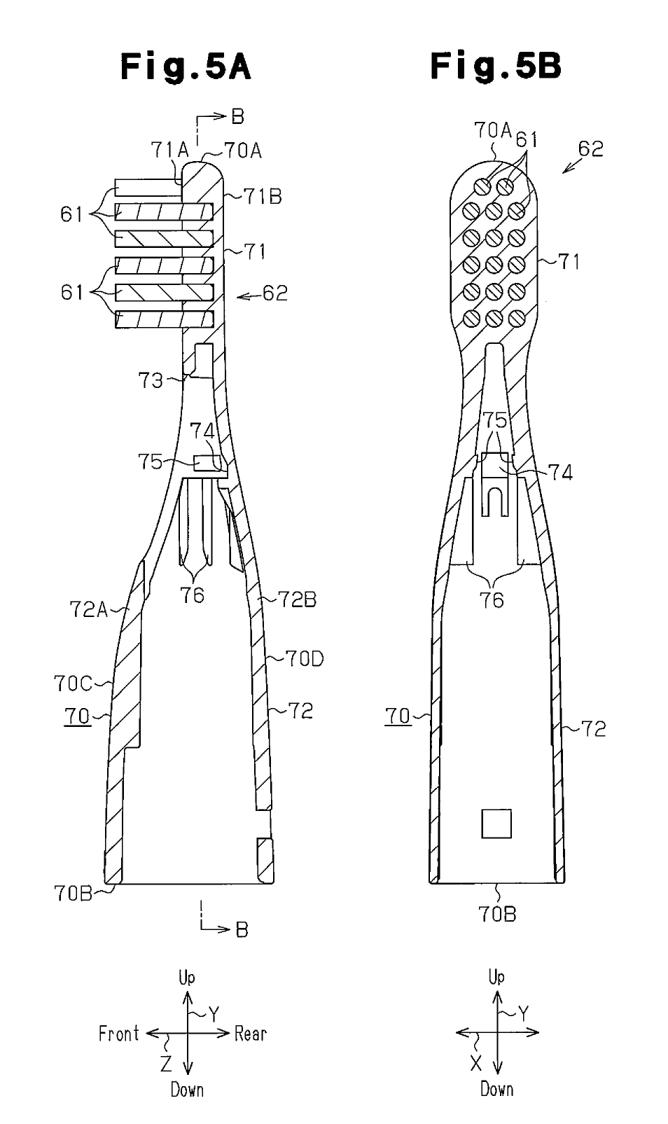

The internal structure of the brush handle 70 will now be described in detail with reference to FIGS. 5A and 5B.

The brush handle 70 includes a fitting portion 74, to which the hook 83A of the transparent member 80 is engaged, protrusions 75, which are fitted in the fitting portions 85 of the transparent member 80, and flat plates 76, which define slots for accommodating the wing portions 84 of the transparent member 80. The flat plates 76 are spaced from each other in the depth direction Z.

The transparent member 80 is coupled to the brush handle 70 through the following procedures. The transparent member 80 is first arranged in the brush handle 70 through the bottom opening of the brush handle 70. The hook 83A of the internal retaining portion 83 is engaged in the fitting portion 74. The fitting portions 85 are engaged with the protrusions 75 of the brush handle 70. The wing portions 84 are arranged in the slots between the flat plates 76 of the brush handle 70.

The operation of the light source 27 will now be described with reference to FIGS. 3A and 3B.

The light source 27 emits light when voltage is applied under the control performed by the computer 23B. The light from the light source 27 passes through the cover 28 and illuminates the interior of the brush handle 70. Further, the light passes through the transparent member 80 and illuminates the brush portion 62 and the surrounding area.

The control of the toothbrush body 10 will now be described with reference to FIGS. 1A to 3B.

The computer 23B executes operation mode control, which controls the operation of the toothbrush body 10 in accordance with the operation of the operational member 26, rotation speed control, which controls the rotation speed of the electric motor 51, and timer control, which manages the operation time of the toothbrush body 10.

Under the operation mode control, the operation mode of the toothbrush body 10 is switched in accordance with the operation of the operational member 26. The toothbrush body 10 has a plurality of operation modes including a first operation mode and a second operation mode. In the first operation mode, the light source 27 is lit, and the electric motor 51 is driven. In the second operation mode, the light source 27 is turned off, and the electric motor 51 is driven.

When the operational member 26 is depressed once in the power-off state, the computer 23B changes to the first operation mode. When the operational member 26 is depressed once in the first operation mode, the computer 23B changes the operation mode to the second operation mode. When the operational member 26 is depressed once in the second operation mode, the computer 23B changes to the power-off state.

The computer 23B executes rotation speed control in the first operation mode or the second operation mode. The rotation speed control includes pulse width modulation (PWM) control of the drive voltage of the electric motor 51 to maintain the rotation speed of the electric motor 51 within a predetermined range. The rotation speed control maintains the magnitude of vibration, which is generated when the electric motor 51 produces rotation, within a predetermined range.

In an example of the rotation speed control, the duty ratio of the voltage provided to the electric motor 51 is changed in the manner described below. When the measured voltage value of the battery 100 is higher than a reference voltage, the computer 23B decreases the duty ratio in accordance with the difference between the drive voltage and the reference voltage of the electric motor 51. When the measured voltage value of the battery 100 is smaller than the reference voltage, the computer 23B increases the duty ratio in accordance with the difference between the drive voltage and the reference voltage of the electric motor 51. When the measured voltage value of the battery 100 is equal to the reference voltage, the computer 23B maintains the default value of the duty ratio.

The reference voltage corresponds to the drive voltage used when rotating the electric motor 51 generates vibrations having a predetermined range of amplitudes. The reference voltage may be preset based on experiments. A single reference voltage may be used, or a range of reference voltages may be used.

Under the timer control, the computer 23B forcibly turns off the power supply in accordance with the period of time for which the first operation mode or the second operation mode is being continuously selected. For example, the computer 23B may stop the operation of the toothbrush body 10 when a predetermined condition is satisfied, without the operational member 26 being operated.

In an example, the operation mode is changed in the manner described below. When the first operation mode is selected in the power-off state, the computer 23B starts counting the elapsed time (first operation time TA). When the first operation time TA is longer than or equal to a determination time TAX, the computer 23B turns off the power supply. The computer 23B starts counting the elapsed time (second operation time TB) when the operation mode changes from the first operation mode to the second operation mode. When the second operation time TB is longer than or equal to the determination time TBX, the computer 23B turns off the power supply.

The determination time TAX may be within a preferable range of a continuous period of time in which vibrations are applied to the teeth in the first operation mode. The determination time TBX may be within a preferable range of a continuous period of time in which vibrations are applied to the teeth in the second operation mode. The determination time TAX and the determination time TBX may be identical values or different values.

The electric toothbrush 1 of the first embodiment has the advantages described below.

(1) The light source 27 of the electric toothbrush 1 is arranged in a portion of the coupling shaft 32, which is covered by the attachment 60. This structure arranges the light source 27 of the main unit 20 near the brush portion 62, and thus allows the light source 27 to illuminate the brush portion 62 more brightly.

(2) The light source 27 emits light toward the brush portion 62. This structure enhances advantage (1).

(3) The transparent member 80 is arranged on the front surface 70C of the brush handle 70. This structure enhances advantage (1).

(4) The transparent member 80 is coupled to the upper inclined portion 72AU of the front inclined portion 72A of the brush handle 70. This structure enhances advantage (1) as compared with the structure in which the transparent member 80 is coupled to another part of the brush handle 70, for example, the lower inclined portion 72AL of the front inclined portion 72A or the side wall of the brush handle 70.

(5) The coupling shaft 32 accommodates the vibration generator 50. This structure reduces the dimension of the toothbrush body 10 in the height direction Y as compared with the structure in which the vibration generator 50 is arranged downward from the coupling shaft 32.

(6) The bristle embedding surface 71A of the brush handle 70 is arranged frontward from the body center line C1. This structure reduces the likelihood of teeth can coming into contact with the front surface 70C of the wall 72 when cleaning teeth as compared with a structure in which the bristle embedding surface 71A is arranged rearward from the body center line C1. As compared with the structure including the bristle embedding surface 71A arranged rearward from the body center line C1, the dimension of the coupling shaft 32 in the depth direction Z is large. The coupling shaft 32 can have a larger inner space, which can be used to accommodate components including the vibration generator 50 and the light source 27.

(7) The ventilation holes 94 to 96 of the cap 90 face the distal ends of the brush bristles 61. This structure allows external air to enter the cap 90 through the ventilation holes 94 to 96 and easily come in contact with the brush bristles 61 thus allowing for the brush bristles 61 to dry easily when the cap 90 is coupled.

(8) The transparent member 80 includes the external retaining portion 82 and the wing portions 84, which are engaged with the rim of the opening 73 of the brush handle 70 and with the slots between the flat plates 76. This structure prevents the transparent member 80 from falling out of the brush handle 70.

(9) The transparent member 80 includes the internal retaining portion 83 and the fitting portions 85, which are engaged with the fitting portion 74 and the protrusions 75 of the brush handle 70. This structure prevents displacement of the transparent member 80 from the predetermined position. Further, the transparent member 80 does not fall out of the opening 73.

(10) The bottom end of the transparent member 80 is positioned near the top end of the coupling shaft 32. This structure allows the coupling shaft 32 to restrict downward movement of the transparent member 80 when the transparent member 80 is removed through the opening 73. For example, the structure of the first embodiment reduces the amount of downward movement of the transparent member 80 as compared with the structure in which the bottom end of the transparent member 80 is positioned far away from the top end of the coupling shaft 32.

(11) The cover 28 is pressed and fitted in the opening 32D of the coupling shaft 32. This structure allows for press-fitting of the cover 28 in the opening 32D and thus reduces water and dust entering the coupling shaft 32.

(12) The operational member 26 is arranged opposite to the brush bristles 61 relative to the body center line C1. When the user intends to clean the teeth of another person facing the user by using the electric toothbrush 1, this structure allows the operational member 26 to be on the user side. In this case, the operational member 26 is easy to operate as compared with the structure in which the operational member 26 is arranged on the same side as the brush bristles 61 relative to the body center line C1.

(13) The toothbrush body 10 of the electric toothbrush 1 includes at least the first operation mode and the second operation mode. This structure allows the user to select the second operation mode when the user does not need illumination with the light source 27. This reduces power consumption of the toothbrush body 10.

(14) The computer 23B of the electric toothbrush 1 controls the rotation speed of the electric motor 51. This structure gives a stable brushing feel to the user in the first operation mode or in the second operation mode.

(15) The computer 23B of the electric toothbrush 1 forcibly turns off the power supply by timer control. This structure prevents the teeth from being subjected to vibrations of the electric motor 51 for a long time. The computer 23B turns off the power supply if the user forgets to switch off the toothbrush body 10 after cleaning the teeth. This reduces unnecessary power consumption of the toothbrush body 10.

(16) The length W of the rear surface of the brush handle 70 is smaller than the front surface length V. This structure allows vibrations of the vibration generator 50 to be transmitted easily to the rear surface 70D of the brush handle 70.

(17) The vibration transmission member 54 of the vibration generator 50 is in contact with the wall of the outer case 30. This structure allows vibrations of the vibration generator 50 to be transmitted easily to the rear inclined portion 72B of the brush handle 70.

(18) The axis of rotation of the electric motor 51 deviates rearward from the center line of the grip case 21. This allows vibrations caused by rotation of the electric motor 51 to be transmitted easily to the rear wall of the grip case 21. In the structure in which the rear wall length Q of the body case 22 is smaller than the front wall length P, such vibrations are less likely to be transmitted to the rear wall of the grip case 21 than in a structure in which the rear wall length Q is larger than the front wall length P. For example, the user receives fewer vibrations from the grip case 21.

In the structure in which the rotation axis of the electric motor 51 deviates rearward from the center line of the grip case 21, fewer vibrations are transmitted from the toothbrush body 10 to the hand of the user.

(19) The difference between the electric toothbrush 1 according to the first embodiment and a comparative example of an electric toothbrush (first comparative toothbrush) will now be described. The first comparative toothbrush differs from the electric toothbrush 1 of the first embodiment only in the structure described below:
The comparative toothbrush eliminates the light source 27 from the coupling shaft 32 of the first embodiment;
The coupling shaft 32 of the first comparative toothbrush is smaller than the coupling shaft in the first embodiment;
The inclination angle of the front inclined portion 72A of the first comparative toothbrush is larger than the inclination angle in first embodiment;
The inclination angle of the rear inclined portion 72B of the first comparative toothbrush is smaller than the inclination angle in the first embodiment; and
The brush portion 62 of the first comparative toothbrush is positioned more rearward than in the first embodiment. The bristle embedding surface 71A of the first comparative toothbrush is positioned more rearward than in the first embodiment.

The first comparative toothbrush eliminates the light source 27, and thus uses no space for accommodating the light source 27 in the coupling shaft 32. This allows the coupling shaft 32 of the first comparative toothbrush to be smaller than the coupling shaft in the first embodiment. This structure needs a smaller space in the brush handle 70 for accommodating the coupling shaft 32, and arranges a portion of the front inclined portion 72A corresponding to the coupling shaft 32 closer to the body center line C1.

In the first comparative toothbrush, a portion of the front inclined portion 72A corresponding to the coupling shaft 32 protrudes frontward by a smaller degree than in the first embodiment, and the inclination angle of the front inclined portion 72A corresponding to the coupling shaft 32 is larger than in the first embodiment.

In the first comparative toothbrush, which has the different inclination angle of the front inclined portion 72A, the bristle embedding surface 71A is positioned rearward from the body center line C1. The brush portion 62 is positioned relatively rearward. The inclination angle of the rear inclined portion 72B is smaller than in the first embodiment. For example, the inclination angle of the rear inclined portion 72B of the first comparative toothbrush relative to the body center line C1 is smaller than the inclination angle of the rear inclined portion 72B in the first embodiment.

As the electric toothbrush 1 of the first embodiment includes the light source 27 arranged in the coupling shaft 32, the first comparative toothbrush is accordingly changed in the manner described below.

For example, the electric toothbrush 1 of the first embodiment uses a space for accommodating the light source 27 in the coupling shaft 32. In this case, the coupling shaft 32 is larger than the first comparative toothbrush. This structure uses a large space in the brush handle 70 for accommodating the coupling shaft 32.

In the first embodiment, the front inclined portion 72A corresponding to the coupling shaft 32 is positioned further farther from the body center line C1 than in the first comparative toothbrush. A portion of the front inclined portion 72A corresponding to the coupling shaft 32 protrudes frontward by a larger degree than in the first comparative toothbrush. The inclination angle of the front inclined portion 72A corresponding to the coupling shaft 32 is smaller than in the first comparative toothbrush.

The bristle embedding surface 71A in the first embodiment may be formed rearward from the body center line C1 in the same manner as in the first comparative toothbrush. However, the bristle embedding surface 71A of the first embodiment is formed frontward from the body center line C1. For example, the brush portion 62 of the first embodiment is formed more frontward than the brush portion 62 of the first comparative toothbrush. This positioning of the brush portion 62 allows the rear inclined portion 72B of the first embodiment to be closer to the body center line C1 than in the first comparative toothbrush. Thus, the inclination angle of the rear inclined portion 72B in the first embodiment is larger than in the first comparative toothbrush.

The toothbrush in which the bristle embedding surface 71A is positioned frontward from the body center line C1 has the advantages described below over another comparative toothbrush (second comparative toothbrush) in which the bristle embedding surface 71A is positioned rearward from the body center line C1. The second comparative toothbrush has the same structure as the electric toothbrush 1 except the different position of the bristle embedding surface 71A described above.

In the second comparative toothbrush, a portion of the front inclined portion 72A corresponding to the coupling shaft 32 protrudes frontward by a larger degree than in the first comparative toothbrush. This allows the front inclined portion 72A to easily come in contact with the teeth when cleaning teeth.

In the electric toothbrush 1, a portion of the front inclined portion 72A corresponding to the coupling shaft 32 protrudes frontward by the same degree as in the second comparative toothbrush. In contrast, the bristle embedding surface 71A is arranged more frontward than in the second comparative toothbrush. For example, the bristle embedding surface 71A is arranged frontward from the body center line C1. This reduces the likelihood that the front inclined portion 72A of the electric toothbrush 1 can come in contact with teeth as compared with the second comparative toothbrush.

For the second comparative toothbrush, the length of the brush bristles 61 may be increased to reduce the likelihood that the front inclined portion 72A can come in contact with the teeth. However, such brush bristles 61 that are longer than a predetermined length (e.g., longer than a length suited to teeth cleaning) can cause discomfort to the user. To prevent this, the bristle embedding surface 71A in the electric toothbrush 1 is arranged more frontward than in the first comparative toothbrush as described above. This reduces the likelihood that the front inclined portion 72A can come in contact with the teeth. In this case, the brush bristles 61 of the electric toothbrush 1 can have a preferable length.

A second embodiment of the present invention will now be described. The second embodiment will be described focusing on the connection between electric components including a light source 27, an electric motor 51, a control board 23, and a relay board 24. The components that are the same as those in the first and second embodiments are given the same reference numerals, and will not be described in detail.

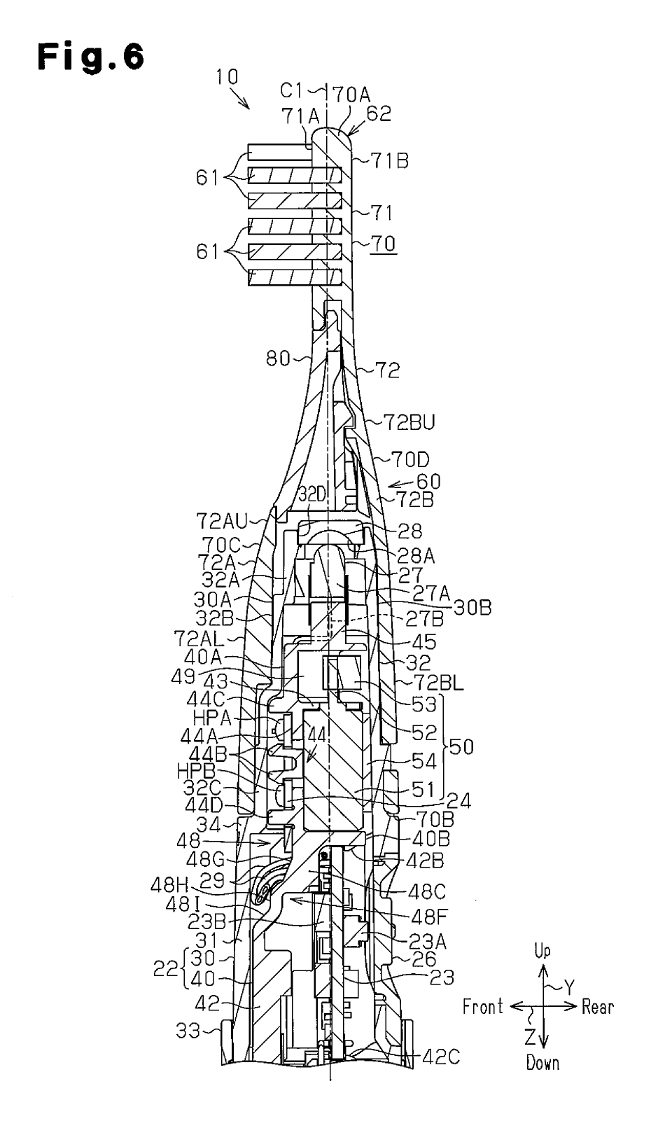

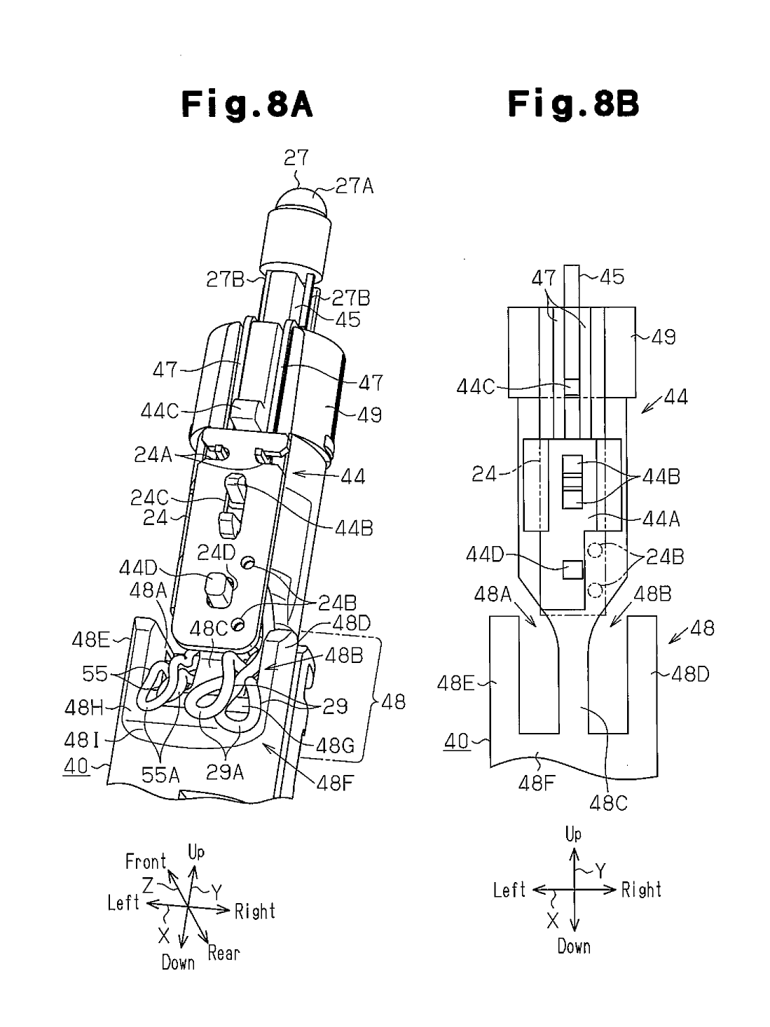

As shown in FIG. 6, the light source 27 includes a light source body 27A, which emits light, and connection terminals 27B, which supply power to the light source body 27A. As shown in FIG. 8A, the vibration generator 50 includes a motor lead wire 55, which supplies power to the electric motor 51.

The light source 27 is electrically connected to the control board 23 by the relay board 24. For example, the connection terminals 27B of the light source 27 are connected to the relay board 24, which is then connected to the control board 23 by a board lead wire 29. The electric motor 51 is connected to the control board 23 by a motor lead wire 55.

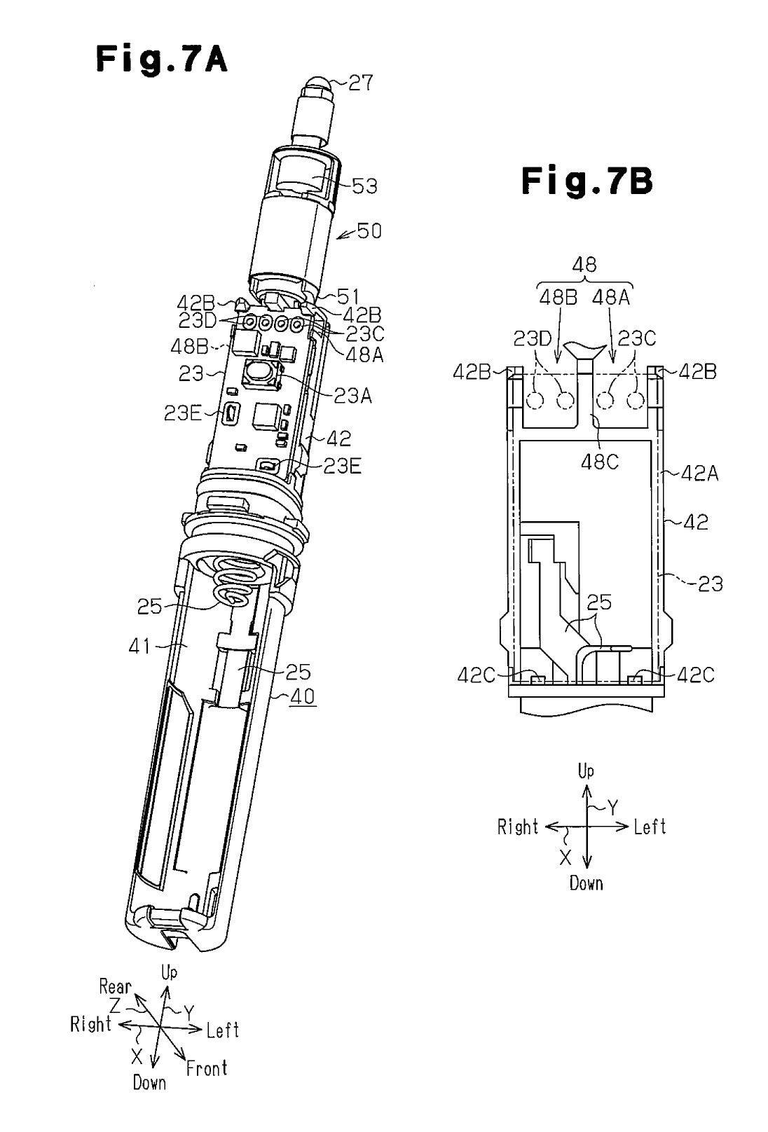

As shown in FIG. 7A, the control board 23 includes connecting portions (also referred to as pads), which are electrically connected to various components. In the illustrated example, the control board 23 includes two motor connecting portions 23C, two board connecting portions 23D, and two battery connecting portions 23E.

The motor connecting portions 23C are electrically connected to the electric motor 51. The motor lead wire 55 is soldered to the motor connecting portions 23C.

The board connecting portions 23D are electrically connected to the relay board 24. The board lead wire 29 is soldered to the board connecting portions 23D.

Each battery connecting portion 23E is electrically connected to the battery 100. The connector 25 is soldered to the battery connecting portions 23E.

The two motor connecting portions 23C are formed at the same position in the height direction Y. The two board connecting portions 23D are formed at the same position in the height direction Y. The motor connecting portions 23C and the board connecting portions 23D are formed at the same position in the height direction Y.

As shown in FIG. 7B, the second coupling portion 42 of the inner case 40 includes a coupling portion 42A to which the control board 23 (indicated by double-dashed line) is coupled, an upper retainer 42B, which is engaged with the top end of the control board 23, and a lower retainer 42C, which is engaged with the bottom end of the control board 23.

The top end of the control board 23 is sandwiched and held between the coupling portion 42A and the upper retainer 42B. The bottom end of the control board 23 is sandwiched and held between the coupling portion 42A and the lower retainer 42C. This restricts movement of the control board 23 in the depth direction Z relative to the second coupling portion 42.

The relay board 24 will now be described. As shown in FIG. 8A, the relay board 24 includes two light source connecting portions 24A, which are connected to the connection terminals 27B of the light source 27, and two lead wire connecting portions 24B, which are connected to the board lead wire 29. In the illustrated example, the relay board 24 has a first through hole 24C, which is an elongated hole corresponding to a holder 44B of the inner case 40, and a second through hole 24D, which is a tetragonal hole corresponding to an upper protrusion 44C of the inner case 40. Although not shown, the relay board 24 includes a circuit pattern connecting each light source connecting portion 24A to the corresponding lead wire connecting portion 24B.

The light source connecting portions 24A include cutoffs, which are recessed from the ends of the relay board 24 in the width direction X to intermediate positions in the width direction X. The connection terminals 27B of the light source 27 are soldered to the light source connecting portions 24A. The board lead wire 29 is soldered to the lead wire connecting portions 24B.

As shown in FIG. 6, the holder 44B, the upper protrusion 44C, and the lower protrusion 44D of the fourth coupling portion 44 come in contact with the inner surface of the outer case 30. This restricts frontward movement of the fourth coupling portion 44 in the depth direction Z relative to the outer case 30.

The solder connections to the fourth coupling portion 44 will now be described with reference to FIG. 6. A solder portion HPA is a connecting point of the light source connecting portions 24A and the connection terminals 27B. A solder portion HPB is a connecting point of the lead wire connecting portion 24B and the board lead wire 29. The tip of the solder portion HPA and the tip of the solder portion HPB are positioned rearward from the holder 44B, the lower protrusion 44D, and the upper protrusion 44C. A space is formed between the tip of each of the solder portions HPA and HPB and the inner surface of the outer case 30.

The relationship between the inner case 40 and the relay board 24 will now be described with reference to FIGS. 8A and 8B.

As shown in FIG. 8B, the fourth coupling portion 44 of the inner case 40 includes a coupling portion 44A, which supports the relay board 24 (indicated by double-dashed line), a hook-shaped holder 44B, which holds the relay board 24, a lower protrusion 44D, which positions the relay board 24 in the height direction Y and the width direction X, and an upper protrusion 44C, which restricts upward movement of the relay board 24.

The coupling portion 44A supports the rear surface of the relay board 24. The holder 44B is engaged with the outer surface of the relay board 24 through the first through hole 24C formed in the relay board 24. This restricts movement of the relay board 24 in the width direction X, the height direction Y, and the depth direction Z relative to the fourth coupling portion 44. The inner case 40 may be referred to as a supporting member.

In the inner case 40, an intermediate portion 49 between the fourth coupling portion 44 and the fifth coupling portion 45 includes two terminal grooves 47, in which the connection terminals 27B of the light source 27 are arranged. The terminal grooves 47 extend in the longitudinal direction (height direction Y) of the inner case 40. The dimension of each terminal groove 47 in the height direction Y, or specifically the depth of each terminal groove 47, is larger than the maximum diameter of each connection terminal 27B.

The connection terminals 27B are arranged in the terminal grooves 47. The connection terminals 27B are arranged rearward from the outer surface of the intermediate portion 49 in the depth direction Z. For example, the connection terminals 27B are entirely in the terminal grooves 47 in the depth direction Z.

The lead wires 29 and 55 will now be described with reference to FIGS. 8A and 8B. As shown in FIG. 8A, a wiring portion 48 for layout out the lead wires 29 and 55 is formed downward from the fourth coupling portion 44 of the inner case 40. The wiring portion 48 includes a guide wall 48F, which is spaced from the outer case 30 (FIG. 6), a connecting wall 48C, which connects the fourth coupling portion 44 and the guide wall 48F, and a right wall 48D and a left wall 48E, which restrict movement of the lead wires 29 and 55 in the width direction X. The space between the guide wall 48F and the outer case 30 is used to lay out the lead wires 29 and 55. The wiring portion 48 (connecting wall 48C) corresponds to an isolating means.

The wiring portion 48 includes a first wiring portion 48A for laying out the motor lead wire 55 and a second wiring portion 48B for laying out the board lead wire 29. The first wiring portion 48A is a space defined by the guide wall 48F, the connecting wall 48C, and the right wall 48D. The second wiring portion 48B is a space defined by the guide wall 48F, the connecting wall 48C, and the left wall 48E.

The outer surface of the guide wall 48F faces the inner surface of the outer case 30. The outer surface of the guide wall 48F includes three surfaces with differing angles of inclination relative to the body center line C1, namely, an upper inclined surface 48G, an intermediate flat surface 48H, and a lower inclined surface 48I. The upper inclined surface 48G and the lower inclined surface 48I are inclined from the rear toward the front in a direction from the upper side toward the lower side. The intermediate flat surface 48H is parallel to the body center line C1.

As shown in FIG. 6, the lower inclined surface 48I is positioned frontward from the upper inclined surface 48G. The space between the outer surface of the guide wall 48F and the inner surface of the outer case 30 is narrower at downward positions than at upward positions.

The first wiring portion 48A and the second wiring portion 48B will now be described. As shown in FIG. 7A, the first wiring portion 48A and the second wiring portion 48B are arranged frontward from the motor connecting portions 23C. As shown in FIG. 7B, the first wiring portion 48A and the second wiring portion 48B are arranged at the same position as the motor connecting portions 23C of the control board 23 in the height direction Y. As shown in FIG. 8B, the lead wire connecting portion 24B of the relay board 24 is at a position corresponding to the second wiring portion 48B in the width direction X.

As shown in FIG. 8A, the motor lead wire 55, which includes a bent portion 55A, is laid out through the wiring portion 48A. The bent portion 55A partially protrudes frontward from the first wiring portion 48A in the depth direction Z. The protruding part of the bent portion 55A can bend along the upper inclined surface 48G and the intermediate flat surface 48H.

As shown in FIG. 8A, the board lead wire 29, which includes a bent portion 29A, is laid out through the second wiring portion 48B. The bent portion 29A partially protrudes frontward from the second wiring portion 48B in the depth direction Z. The protruding part of the bent portion 29A can bend along the upper inclined surface 48G and the intermediate flat surface 48H.

The electric toothbrush 1 of the second embodiment has the advantages described below in addition to the advantages described in the first embodiment.

(20) The electric toothbrush 1 includes the relay board 24 for electrically connecting the light source 27 and the control board 23. The light source 27 is directly connected to the relay board 24. This structure eliminates the need for lead wires that connect the light source 27 and the control board 23, and thus simplifies the process of coupling various components to the body case 22 as compared with a structure that does not include the relay board 24.

(21) In the electric toothbrush 1, the third coupling portion 43, to which the vibration generator 50 is coupled, the fourth coupling portion 44, to which the relay board 24 is coupled, and the fifth coupling portion 45, to which the light source 27 is coupled, are formed integrally. This structure allows the light source 27 and the relay board 24 to vibrate substantially in the same phase when the vibration generator 50 vibrates. This prevents large stress from being applied to the connection portion of the light source 27 and the relay board 24 when the vibration generator 50 vibrates.

(22) In the electric toothbrush 1, the terminal grooves 47 are formed in the intermediate portion 49 of the inner case 40. The connection terminals 27B are arranged in the terminal grooves 47. This structure allows the connection terminals 27B to protrude less from the outer surface of the intermediate portion 49 than in the structure in which no terminal grooves 47 are formed in the intermediate portion 49, specifically, the structure in which the connection terminals 27B are entirely arranged on the outer surface of the intermediate portion 49.

(23) In the electric toothbrush 1, the relay board 24 and the control board 23 are arranged parallel to each other. The lead wire connecting portion 24B of the relay board 24 and the board connecting portion 23D of the control board 23 are positioned to correspond to each other in the width direction X. This structure reduces the length of the board lead wire 29.

(24) In the electric toothbrush 1, the motor lead wire 55 is laid out through the first wiring portion 48A. The board lead wire 29 is laid out through the second wiring portion 48B. This structure prevents the motor lead wire 55 and the board lead wire 29 from intersecting with each other.

(25) The electric toothbrush 1 includes the first wiring portion 48A, which is defined by the upper inclined surface 48G, the connecting wall 48C, and the right wall 48D. In this structure, the right wall 48D prevents the motor lead wire 55 from moving out of the first wiring portion 48A in the width direction X. This prevents the motor lead wire 55 from being caught between the outer case 30 and the inner case 40 when the outer case 30 and the inner case 40 are coupled together.

(26) The electric toothbrush 1 includes the second wiring portion 48B, which is defined by the upper inclined surface 48G, the connecting wall 48C, and the left wall 48E. In this structure, the left wall 48E prevents the board lead wire 29 from moving out of the second wiring portion 48B in the width direction X. This prevents the board lead wire 29 from being caught between the outer case 30 and the inner case 40 when the outer case 30 and the inner case 40 are coupled together.

(27) In the electric toothbrush 1, the angle formed by the upper inclined surface 48G and the intermediate flat surface 48H at the side cross-section is an obtuse angle. The part of the motor lead wire 55 protruding from the first wiring portion 48A in the depth direction Z, and the part of the board lead wire 29 protruding from the second wiring portion 48B in the depth direction Z are both positioned upward from the upper inclined surface 48G. This structure reduces damage to the coating of the motor lead wire 55 and the board lead wire 29 as compared with the structure in which right angled corner portions can come in contact with the protruding parts of the motor lead wire 55 and the board lead wire 29.

(28) In the electric toothbrush 1, the upper protrusion 44C and the lower protrusion 44D protrude frontward from the solder portion HPA and the solder portion HPB. The upper protrusion 44C and the lower protrusion 44D come in contact with the inner surface of the outer case 30. This structure reduces the likelihood that the solder portion HPA and the solder portion HPB can come in contact with the inner surface of the outer case 30.

The present invention should not be limited to the first and second embodiments, but may be modified in the following forms. Such modifications may be combined with one another.

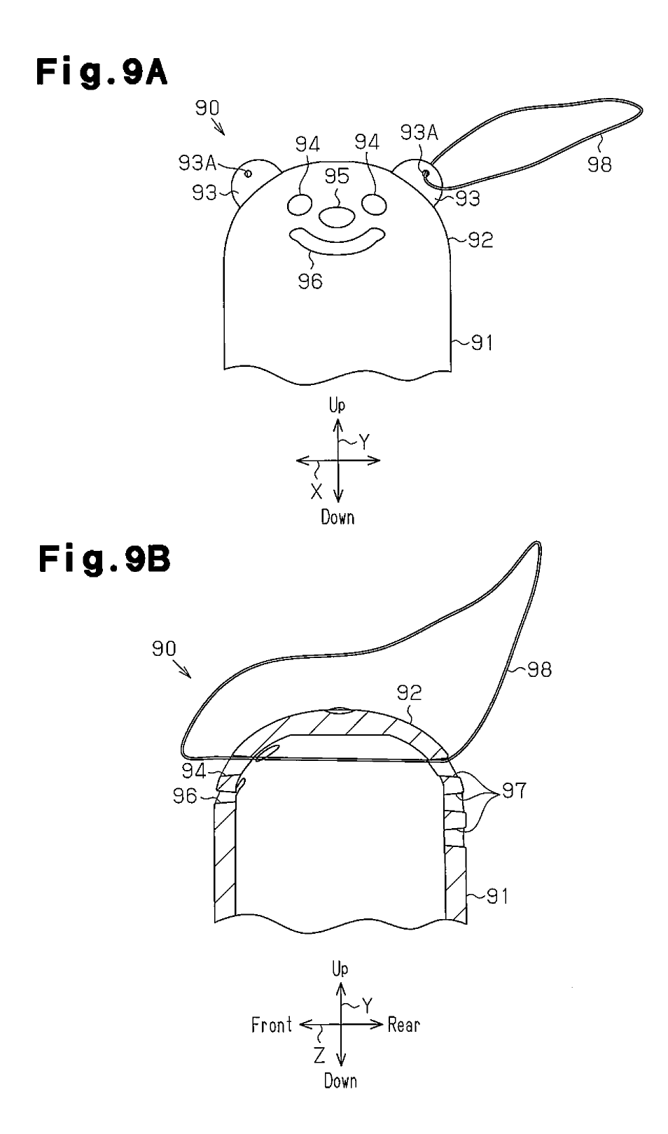

In the above embodiments, a strap may be attached to the cap 90. As shown in FIG. 9A, for example, each protrusion 93 of the cap 90 may have a through hole 93A, through which the strap 98 is to be inserted, or only one of the protrusions 93 of the cap 90 may have a through hole 93A. As shown in FIG. 9B, the strap 98 may be attached to the cap 90 by inserting it through one ventilation hole 94 and one ventilation hole 97. The strap 98 may be attached to the cap 90 by inserting it through at least two of the ventilation holes 94 to 97.

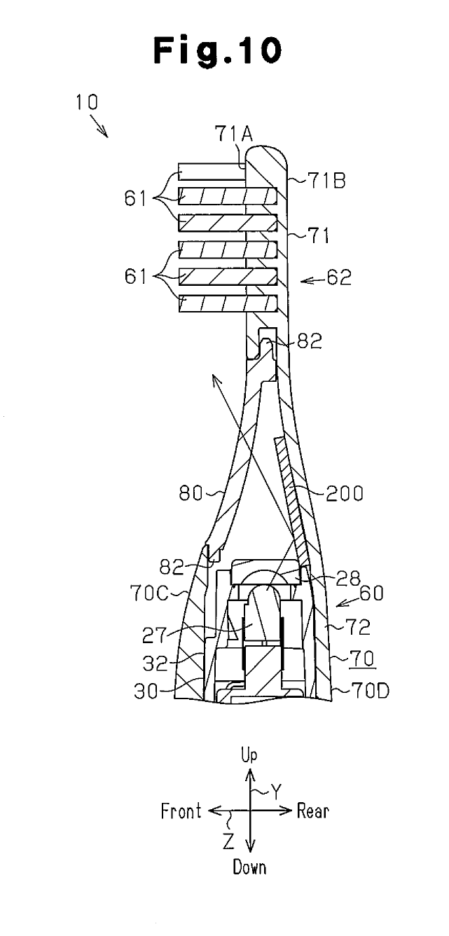

In the above embodiments, the brush handle 70 may include a reflective member for reflecting light from the light source 27. For example, the brush handle 70 shown in FIG. 10 includes a reflective member 200, which is arranged on the rear inclined portion 72B. The reflective member 200 reflects light from the light source 27 toward the transparent member 80. This structure illuminates the front side of the attachment 60 more brightly with light from the light source 27.

In the above embodiments, the light source 27 is a bullet type light emitting diode (LED) but may be a chip type LED. Alternatively, the light source 27 may be an incandescent bulb or a discharge bulb.

In the above embodiments, the cover 28 is fixed to the coupling shaft 32 through pressure fitting. Alternatively, the cover 28 may be fixed to the coupling shaft 32 through ultrasonic welding.

In the above embodiments, the upper surface of the cover 28 is flat but may have another shape. For example, the upper surface of the cover 28 may be curved and protrude upward or may be inclined upward toward the rear.

In the above embodiments, the lower surface of the cover 28 may be flat and has no recess 28A. This structure prevents light emitted from the light source 27 from diverging in the width direction X and the depth direction Z through the cover 28 and thus illuminates the brush portion 62 more brightly.

In the above embodiments, the material for the cover 28 and the transparent member 80 should not be limited to ABS resin. For example, at least one of the cover 28 and the transparent member 80 may be formed from polycarbonate or polypropylene. A cover and a transparent member formed from polycarbonate will have a higher transmittance than when ABS resin is used. A cover and a transparent member formed from polypropylene will have a higher resistance to chemicals than when ABS resin is used.

In the above embodiments, the opening 73 of the brush handle 70 and the transparent member 80 may be eliminated. This structure also has the above advantages excluding advantages (3), (4), and (8) to (10).

In the above embodiments, the opening 73 is formed in the front inclined portion 72A of the brush handle 70. However, the opening 73 does not have to be formed in the front surface 70C. The opening 73 may be formed, for example, in the rear inclined portion 72B of the brush handle 70.

In the above embodiments, the vibration generator 50 is entirely accommodated in the coupling shaft 32. However, a portion of the vibration generator 50 may be arranged downward from the coupling shaft 32. Alternatively, the entire vibration generator 50 may be arranged downward from the coupling shaft 32.

Each of the above embodiments may additionally include a third operation mode. In the third operation mode, the light source 27 is lit, and the electric motor 51 is stopped. The third operation mode may be selected in an order based on the operation of the operational member 26 that comes before the first operation mode, after the first operation mode, or after the second operation mode.

Each of the above embodiments may additionally include an eleventh operation mode and a twelfth operation mode (modification A). The eleventh operation mode applies stronger vibrations to the teeth than the first operation mode. The twelfth operation mode applies weaker vibrations to the teeth than the first operation mode. In the eleventh operation mode and the twelfth operation mode, the light source 27 is lit in the same manner as in the first operation mode.

In the eleventh operation mode and the twelfth operation mode, the computer 23B performs rotation speed control in the manner described below. Under the rotation speed control performed in the first operation mode, the computer 23B adjusts the rotation speed of the electric motor 51 to be in a target range, that is, an intermediate predetermined range.

In the eleventh operation mode, the computer 23B maintains the rotation speed of the electric motor 51 in the predetermined range that is larger than the target range of the first operation mode (intermediate predetermined range) by changing the drive voltage of the electric motor 51 through pulse width modulation (PWM) control. In the twelfth operation mode, the computer 23B maintains the rotation speed of the electric motor 51 in the predetermined range that is smaller than the target range of the first operation mode by changing the drive voltage of the electric motor 51 through PWM control.

In modification A, one of the first operation mode, the eleventh operation mode, and the twelfth operation mode may be eliminated.

Modification A may additionally include another operational member that is manually operated to change from the first operation mode to the eleventh operation mode or to the twelfth operation mode. In this case, the computer 23B changes the operation mode and turns the power supply on and off in response to the operation of the operational member 26 in the same manner as in the first embodiment. In the first operation mode, the computer 23B changes the operation mode in the order of the eleventh operation mode, the twelfth operation mode, and the first operation mode whenever the other operational member is operated. The order in which the operation modes are selected in response to the operation of the other operational member should not be limited to the above order and may be freely set in advance.

Each of the above embodiments may additionally include a twenty first operation mode and a twenty second operation mode (modification B). The twenty first operation mode applies stronger vibrations to the teeth than the second operation mode. The twenty second operation mode applies weaker vibrations to the teeth than the second operation mode. In the twenty first operation mode and the twenty second operation mode, the light source 27 is turned off like in the second operation mode.

In the twenty first operation mode, the computer 23B performs the same rotation speed control as the eleventh operation mode. In the twenty second operation mode, the computer 23B performs the same rotation speed control as the twelfth operation mode.

In the above modification B, one of the second operation mode, the twenty first operation mode, and the twenty second operation mode may be eliminated.

The above modification B may additionally include another operational member, with which the user changes the operation mode from the second operation mode to the twenty first operation mode or the twenty second operation mode. The selection of the operation mode in response to the operation of the other operational member may be based on the selection used for the above modification A.

Modification A and modification B may be combined. In this case, the other operational member used in modification A and the other operational member used in modification B may be arranged separately, or a single operational member may function as the other operation members used in the modifications A and B.

In the above embodiments, the toothbrush body 10 includes the vibration generator 50. The vibration generator 50 may be eliminated from the toothbrush body 10. This eliminates the mechanism for coupling the vibration generator 50 to the body case 22.

The electric toothbrush may eliminate the function of applying vibrations to the teeth as long as it includes a functional unit that operates on power supplied from the power supply, such as the light source that illuminates the brush portion. This structure has the above advantages excluding advantages (5), and (6) to (18).

Although the relay board 24 is arranged on the front side of the inner case 40 in the second embodiment (FIG. 6), the relay board 24 may be arranged on the rear side of the inner case 40. In this case, the fourth coupling portion 44 is formed on the rear side of the inner case 40.

In the second embodiment (FIGS. 8A and 8B), the holder 44B is formed upward from the lower protrusion 44D in the fourth coupling portion 44. Alternatively, the holder 44B may be formed downward from the lower protrusion 44D.

Although the inner case 40 is a single member in the second embodiment (FIGS. 7A and 7B), the inner case 40 may be formed by combining a plurality of components. For example, a component including the first coupling portion 41, a component including the second coupling portion 42, a component including the third coupling portion 43, a component including the fourth coupling portion 44, and a component including the fifth coupling portion 45 may be combined together to form the inner case 40.

In the second embodiment (FIGS. 8A and 8B), the terminal grooves 47 may be eliminated. In this case, the connection terminals 27B of the light source 27 are arranged on the outer surface of the intermediate portion 49 of the inner case 40.

Although the first wiring portion 48A and the second wiring portion 48B are open in the depth direction Z in the second embodiment (FIGS. 7A and 7B), the first wiring portion 48A and the second wiring portion 48B may be open in the width direction X.

Although the isolating means in the second embodiment (FIGS. 7A and 7B) is formed by the first wiring portion 48A and the second wiring portion 48B of the inner case 40, the isolating means should not be limited to this structure. The isolating means may be, for example, a hook on which a lead wire is hooked to hold the lead wire on the inner case 40.

In the second embodiment (FIGS. 8A and 8B), the light source 27 is connected directly to the relay board 24 with the connection terminals 27B, and the control board 23 is connected to the relay board 24 by the board lead wire 29. Alternatively, these components may be connected in the following manner.

(A) The light source 27 is connected to the relay board 24 by a lead wire. The control board 23 is directly connected to the relay board 24 by a connector.

(B) The light source 27 is connected to the relay board 24 with a lead wire. The control board 23 is connected to the relay board 24 by a lead wire.

(c) The light source 27 is directly connected to the relay board 24 with the connection terminals 27B. The control board 23 is directly connected to the relay board 24 by a connector.

The structures (A) and (B) shorten the length of the lead wire for electrically connecting the light source 27 and the control board 23 as compared with a structure that does not include the relay board 24. This simplifies the process of coupling the components to the body case 22. The above structure (C) eliminates the lead wire for electrically connecting the light source 27 and the control board 23 as compared with a structure that does not include the relay board 24. This simplifies the process of coupling the components to the body case 22.

Although the first and second embodiments include the light source 27 as its functional unit, another component may be arranged instead of the light source 27. One such example may be a sound output unit for outputting a sound, such as a warning sound. When the first or second embodiment includes a component other than the light source 27 as its functional unit, the transparent member 80 and the opening 73 may be eliminated from the attachment 60.

### Referential Example 1

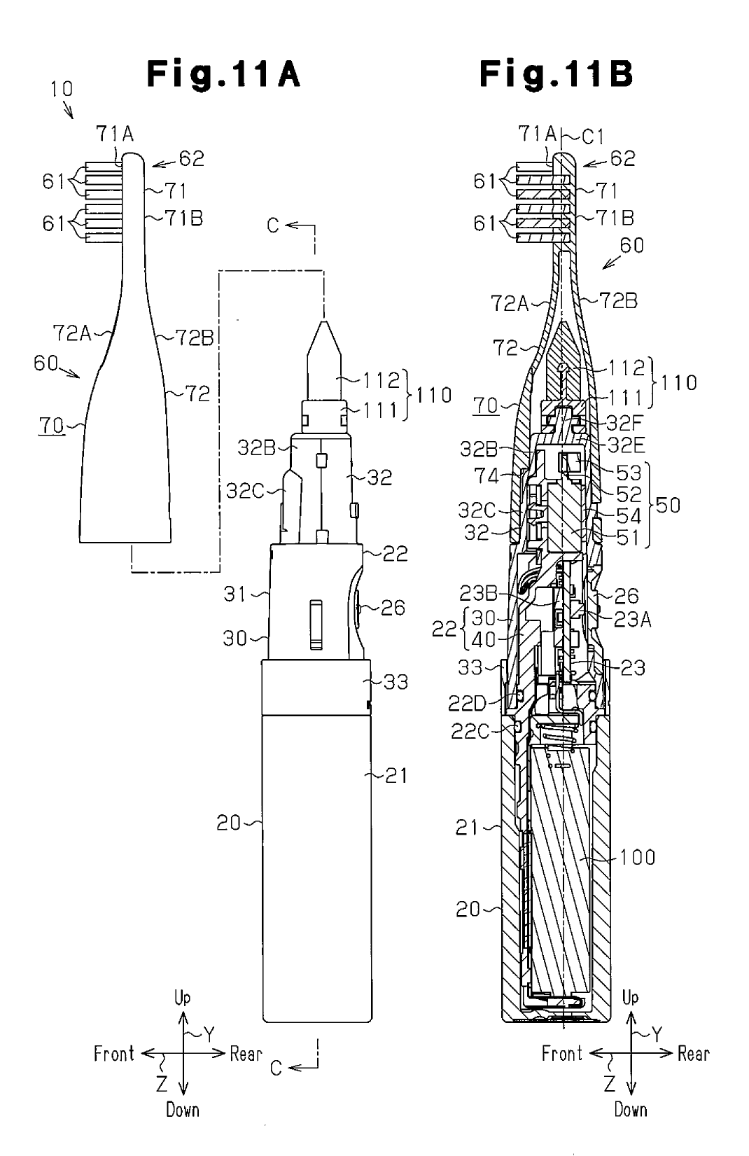

FIGS. 11A and 11B show an electric toothbrush according to referential example 1. The electric toothbrush according to referential example includes a toothbrush body 10, and the cap 90 shown in FIGS. 1A and 1B. The electric toothbrush of the referential example 1 differs from the electric toothbrushes 1 of the first and second embodiments in the structure described below.

Instead of the light source 27A, a stain care attachment 110 is coupled to the distal end of the coupling shaft 32. The distal end shaft 32A of the coupling shaft 32 and the cover 28 are eliminated. The transparent member 80 is eliminated from the attachment 60. The opening 73, the fitting portion 74, the protrusions 75, and the flat plate 76 are eliminated from the brush handle 70. A tip wall 32E is formed on the intermediate shaft 32B of the coupling shaft 32. A coupling portion 32F, to which the stain care attachment 110 is coupled, is formed on the tip wall 32E of the coupling shaft 32.

In referential example 1, the stain care attachment 110 is coupled to the coupling shaft 32 in a removable manner. The stain care attachment 110 includes a base 111, which is connected to the coupling portion 32F, and a brushing portion 112, which protrudes upward from the base 111.

When the attachment 60 is set on the body case 22, the stain care attachment 110 is accommodated in the inner space of the attachment 60. To use the stain care attachment 110, the attachment 60 is removed from the body case 22.

### Referential Example 2

An electric toothbrush of a referential example 2 includes a teeth cleaning functional member that differs from the stain care attachment 110 of referential example 1. This functional member is arranged on the coupling shaft 32. Examples of this functional member include a gum massaging attachment, a spot-brushing toothbrush, a nail polishing attachment, an interdental brush, a dentifrice tube, a ring for adjusting vibrations, and a sound output device for outputting, for example, a warning sound.

1. An electric toothbrush comprising:
a main body member accommodating a power supply;
a cleaning member coupled to the main body member in a removable manner, wherein the cleaning member includes a brush portion;
a coupling shaft arranged on the main body member, wherein the coupling shaft is received by the cleaning member when the cleaning member is coupled to the main body member; and
a light source arranged in a portion of the coupling shaft that is covered by the cleaning member.

2. The electric toothbrush according to claim 1, wherein the light source is arranged in a distal portion of the coupling shaft.

3. The electric toothbrush according to claim 1, further comprising a vibration generator arranged in the main body member, wherein at least a portion of the vibration generator is arranged in the coupling shaft.

4. The electric toothbrush according to claim 3, wherein the light source is arranged in a portion of the coupling shaft that is closer to the brush portion than the vibration generator.

5. The electric toothbrush according to claim 1, wherein the light source emits light toward the brush portion.

6. The electric toothbrush according to claim 5, wherein
the cleaning member includes an outer wall surrounding the coupling shaft, and
a portion of the outer wall between the brush portion and the light source is formed from a transparent material.

7. The electric toothbrush according to claim 6, wherein bristles of the brush portion are arranged on a front surface of the brush portion, and the transparent member is arranged on a front surface of the outer wall.

8. The electric toothbrush according to claim 7, wherein the front surface of the outer wall includes a front inclined portion inclined in a manner to approach a center line of the main body member in a direction from the main body member toward the brush portion.

9. The electric toothbrush according to claim 7, wherein the transparent member is inclined toward the brush portion.

10. The electric toothbrush according to claim 6, further comprising a reflective member that reflects light from the light source toward the transparent member.

11. The electric toothbrush according to claim 1, wherein
the brush portion includes a bristle embedding surface in which brush bristles are embedded, and the bristle embedding surface is arranged frontward from a center line of the main body member.

12. The electric toothbrush according to claim 1, further comprising a cap covering the cleaning member, wherein the cap includes a ventilation hole that faces distal ends of brush bristles of the brush portion.

13. The electric toothbrush according to claim 1, further comprising:
a control board that controls the light source; and
a relay board that electrically connects the light source and the control board,
wherein the light source, the control board, and the relay board are arranged in the main body member.

14. The electric toothbrush according to claim 13, wherein
the main body member includes a supporting member, and
the light source, the vibration generator, and the relay board are coupled to the supporting member.

15. The electric toothbrush according to claim 14, wherein the supporting member includes a terminal groove formed for arrangement of a connection terminal of the light source.

16. The electric toothbrush according to claim 14, further comprising:
a device lead wire that connects the vibration generator and the control board; and
a board lead wire that connects the relay board and the control board, wherein
the relay board and the control board are arranged parallel to each other and parallel to a center line of the main body member,
the control board includes a first connecting portion, which is connected to the device lead wire, and a second connecting portion, which is connected to the board lead wire, and the first connecting portion and the second connecting portion are respectively arranged at the same height in a first area and a second area sandwiching the center line of the main body member, and
the relay board includes a third connecting portion connected to the board lead wire, and the third connecting portion is formed at a position corresponding to the second area of the control board including the second connecting portion.

17. The electric toothbrush according to claim 14, further comprising:
a device lead wire that connects the vibration generator and the control board;
a board lead wire that connects the relay board and the control board; and
an isolating means arranged in the main body member to isolate the device lead wire from the board lead wire.

18. The electric toothbrush according to claim 13, wherein
the light source and the relay board are arranged in a portion of the coupling shaft that is covered by the cleaning member, and
at least a portion of the control board is arranged in a portion of the main body member that is not covered by the cleaning member.
